(19) United States
(12) Patent Application Publication
(10) Pub. No.: US 2021/0142624 A1
(43) Pub. Date: May 13, 2021

(54) E-SPORTS BETTING PLATFORM

(71) Applicant: Sony Interactive Entertainment Inc., Tokyo (JP)

(72) Inventor: Michael Chow, San Mateo, CA (US)

(21) Appl. No.: 16/678,630

(22) Filed: Nov. 8, 2019

(51) Int. Cl. G07F 17/32; G06F 9/451; G06N 5/04; G06Q 50/34

(52) U.S. Cl. CPC G07F 17/3288; G06F 9/451; G07F 17/3211; G06Q 50/34; G07F 17/3244; G06N 5/04

(57) ABSTRACT

Odds for various propositions concerning the play of a computer simulation are determined and presented to a viewer for pecuniary or non-pecuniary wagering purposes. The odds may be determined using past game analytics, or may be determined parimutuelly.

### FIELD

The application relates generally to technically inventive, non-routine solutions that are necessarily rooted in computer technology and that produce concrete technical improvements.

### BACKGROUND

As understood herein, computer simulations such as computer games offer the possibility of a wide range of interesting wagers among gamers and spectators, such as the winner of the game, the next player to virtually “die”, etc.

### SUMMARY

Accordingly, a system includes at least one computer simulation controller and at least one computer simulation source configured to receive input from the computer simulation controller to control presentation of a computer simulation presented on at least one display. The computer simulation source, which may be established by a network server or a simulation console, includes at least one processor and at least one storage accessible to the processor with instructions executable by the processor to establish, for at least one simulation proposition, wagering odds. The instructions are executable to overlay on the computer simulation at least one user interface (UI) configured to enable input, using the simulation controller, of a bet using the wagering odds. Further, the instructions are executable to, based on an outcome of the simulation proposition, present indication of a winner of the bet.

The instructions can be executable to remove the UI from the computer simulation responsive to input from the simulation controller. In some examples the instructions are executable to present recommended wagers output by a recommendation engine. If desired the instructions may be executable to present a list of available bets. The instructions can be executable to accept input of a custom bet.

The wagering odds may be established parimutuelly. The wagering odds may be established using past simulation play statistics.

In another aspect, a method includes establishing odds for at least one future event in a computer simulation, and overlaying onto at least one presentation of the computer simulation at least one user interface (UI) showing the odds and indicating the event to permit a viewer to select to bet on the future event occurring or not.

In another aspect, an apparatus includes at least one computer storage that is not a transitory signal and that includes instructions executable by at least one processor to overlay on a computer simulation being presented on a display at least one wagering proposition related to the computer simulation. The instructions are executable to send acceptance of the wagering proposition to a wagering source.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 is a flow chart of example logic consistent with present principles;

FIG. 3 is a screen shot of an example user interface (UI) for e-betting consistent with present principles;

FIG. 4 is a flow chart of example logic for proposition bets consistent with present principles; and

FIGS. 5 and 6 are screen shots of additional example UIs.

### DETAILED DESCRIPTION

This disclosure relates generally to computer ecosystems including aspects of consumer electronics (CE) device networks such as but not limited to computer simulation networks such as computer game networks as well as standalone computer simulation systems. A system herein may include server and client components, connected over a network such that data may be exchanged between the client and server components. The client components may include one or more computing devices including game consoles such as Sony PlayStation® or a game console made by Microsoft or Nintendo or other manufacturer virtual reality (VR) headsets, augmented reality (AR) headsets, portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to Java, C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). However, the AVD 12 alternatively may be an appliance or household item, e.g. computerized Internet enabled refrigerator, washer, or dryer. The AVD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVD 12 is configured to undertake present principles (e.g. communicate with other CE devices to undertake present principles, execute the logic described herein, and perform any other functions and/or operations described herein).

Accordingly, to undertake such principles the AVD 12 can be established by some or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as e.g. an audio receiver/microphone for e.g. entering audible commands to the AVD 12 to control the AVD 12. The example AVD 12 may also include one or more network interfaces 20 for communication over at least one network 22 such as the Internet, an WAN, an LAN, etc. under control of one or more processors 24 including. A graphics processor 24A may also be included. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVD 12 may also include one or more input ports 26 such as, e.g., a high definition multimedia interface (HDMI) port or a USB port to physically connect (e.g. using a wired connection) to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player containing content that might be regarded by a user as a favorite for channel assignation purposes described further below. The source 26a when implemented as a game console may include some or all of the components described below in relation to the CE device 44.

The AVD 12 may further include one or more computer memories 28 such as disk-based or solid state storage that are not transitory signals, in some cases embodied in the chassis of the AVD as standalone devices or as a personal video recording device (PVR) or video disk player either internal or external to the chassis of the AVD for playing back AV programs or as removable memory media. Also in some embodiments, the AVD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVD 12 is disposed in conjunction with the processor 24. However, it is to be understood that another suitable position receiver other than a cellphone receiver, GPS receiver and/or altimeter may be used in accordance with present principles to e.g. determine the location of the AVD 12 in e.g. all three dimensions.

Continuing the description of the AVD 12, in some embodiments the AVD 12 may include one or more cameras 32 that may be, e.g., a thermal imaging camera, a digital camera such as a webcam, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command, etc.) providing input to the processor 24. The AVD 12 may include an over-the-air TV broadcast port 38 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12.

Still referring to FIG. 1, in addition to the AVD 12, the system 10 may include one or more other CE device types. In one example, a first CE device 44 may be a computer simulation console receiving input from one or more computer simulation controllers to send computer game audio and video to the AVD 12 via commands sent directly to the AVD 12 and/or through the below-described server while a second CE device 46 may include similar components as the first CE device 44. In the example shown, the second CE device 46 may be configured as a VR headset worn by a player or spectator 47 as shown, who may also operate a spectator CE device to observe the computer simulation being sourced to the AVDD 12. In the example shown, only two CE devices 44, 46 are shown, it being understood that fewer or greater devices may be used. For example, principles below discuss multiple spectators 47 with respective headsets or CE device mays observe and wager on the outcome of a computer simulation being played by players, it being understood that the spectators typically do not provide input to control characters in the simulation.

In the example shown, to illustrate present principles all three devices 12, 44, 46 are assumed to be members of an entertainment network in, e.g., a home, or at least to be present in proximity to each other in a location such as a house. However, present principles are not limited to a particular location, illustrated by dashed lines 48, unless explicitly claimed otherwise.

The example non-limiting first CE device 44 may be established by any one of the above-mentioned devices, for example, a portable wireless laptop computer or notebook computer or game console or controller, and accordingly may have one or more of the components described below. The first CE device 44 may be a remote control (RC) for, e.g., issuing AV play and pause commands to the AVD 12, or it may be a more sophisticated device such as a tablet computer, a game controller communicating via wired or wireless link with the AVD 12 and/or a game console, a personal computer, a wireless telephone, etc.

Accordingly, the first CE device 44 may include one or more displays 50 that may be touch-enabled for receiving user input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. A graphics processor 58A may also be included. Thus, the interface 56 may be, without limitation, a Wi-Fi transceiver, which is an example of a wireless computer network interface, including mesh network interfaces. It is to be understood that the processor 58 controls the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a HDMI port or a USB port to physically connect (e.g. using a wired connection) to another CE device and/or a headphone port to connect headphones to the first CE device 44 for presentation of audio from the first CE device 44 to a user through the headphones. The first CE device 44 may further include one or more tangible computer readable storage medium 62 such as disk-based or solid-state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 78 such as an IR data association (IRDA) device. A battery (not shown) may be provided for powering the first CE device 44. The CE device 44 may communicate with the AVD 12 through any of the above-described communication modes and related components.

The second CE device 46 may include some or all of the components shown for the CE device 44. Either one or both CE devices may be powered by one or more batteries.

Now in reference to the afore-mentioned at least one server 80, it includes at least one server processor 82, at least one tangible computer readable storage medium 84 such as disk-based or solid state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server or an entire server “farm”, and may include and perform “cloud” functions such that the devices of the system 10 may access a “cloud” environment via the server 80 in example embodiments for, e.g., network gaming applications. Or, the server 80 may be implemented by one or more game consoles or other computers in the same room as the other devices shown in FIG. 1 or nearby.

The methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a CD ROM or Flash drive. The software code instructions may alternatively be embodied in a transitory arrangement such as a radio or optical signal, or via a download over the internet.

FIG. 2 illustrates logic that may be executed by any combination of servers, simulation consoles, and attendant spectator devices. Commencing at block 200, game analytics are accessed. These analytics can include the past histories of teams and/or individuals playing a current simulation such as an e-sports or other simulation (e.g., a computer game) on which wagering is offered to spectators viewing simulation play on their own devices. The past histories may be confined to prior play of the computer simulation being wagered on or it may encompass some or all prior simulations the players have engaged in. Statistics may include, e.g., win-loss ratios, “kill” statistics, highest simulation level achieved, etc.

Moving to block 202, based on the game analytics from block 200 the odds for one or more proposition bets related to various outcomes of simulation play are determined. Machine learning may be used to learn correct odds based on a training set that can include past proposition bets and odds along with the ground truth outcomes of those propositions.

Initially, the proposition bets may be defined by a simulation provider or other entity. Without limitation, the proposition bets can include straightforward bets on one side or the other winning the simulation; total and individual point scores; over-under bets; and a wide range of specialty bets, such as whether a character will be “killed” in the next X minutes, etc. Proposition bets also may be defined to be offered by a machine learning algorithm accessing past wagering simulations to identify what types of proposition bets were the most popular in the past. Moreover, a simulation provider or a machine learning algorithm may be used to identify highlights in the simulation video and/or audio and/or haptic generation to identify important events in the simulation, with proposition bets being developed around the outcomes of the important events.

Still further, understanding that simulation video frames can contain metadata identifying a particular player, data in a “data ocean” can be accessed to obtain statistics to support betting. For example, video may be searched to identify where in the video a virtual grenade has the possibility of killing one, two, or three characters. The statistics of the player are accessed and then proposition bets with respective odds offered for whether the player kills all three characters with one grenade or not.

Once the proposition bets are defined, the odds for those bets are established either by a human or by an algorithm accessing the game analytic data of some or all of the simulation participants.

Moving to block 204, the proposition bets and attendant odds are provided to the spectators of the simulation. Proceeding to block 206, the odds may be changed depending on how much simulation time remains and/or based on parimutuel wagering (block 208) discussed further below. Thus, the odds can change during simulation play.

Block 210 indicates that acceptance of the offered wagers is received from the spectators. As a proposition is resolved, the results and payouts are returned to the spectators at block 212.

Wagers may be pecuniary, e.g., money or bitcoin, or may be non-pecuniary, e.g., game assets, digital rights, and virtual currency. When wagers are pecuniary the odds offered may account for government take out, e.g., if the calculated odds are 5-1, the offered odds may be reduced to 4-1 to allow for some wagering assets to remain after payouts for the purpose of paying government take out. Wagering assets may be tied to a spectator's electronic wallet.

FIG. 3 illustrates present principles as reflected in a user interface (UI) 300 that may be present on the AVDD 12 or other display(s) viewed by the spectators. The UI 300 may be a real time overlay on a computer simulation video such as an e-sport video 302.

As shown, the UI 300 may include a list 304 of entities against whom the spectator viewing the UI 300 would like to bet. In the example shown, the list 304 is derived from a friends list, and also may include an entry 306 allowing the spectator to select to bet against the house, in this case, the entity offering the wagers, similar to sports betting in a casino or racetrack. If a friend is selected from the list, a challenge can be sent to a device associated with the selected friend that the spectator viewing the UI 300 proposes a bet.

That bet may be selected from a list 308 of proposition bets with respective odds 310. In the example shown, two proposition bets are illustrated, the first being that a particular character (“A”) gets hit by a virtual weapon at any time during simulation play and the second that the character is hit within the next minute (with attendant higher odds as shown). The challenged spectator from the friend's list 304 may choose to accept or decline the proffered bet. When the house 306 is chosen, the house typically must accept the bet.

Additionally, one or more fields 312 may be provided in the UI 300 to permit the spectator to enter his or her own proposition bet with odds the spectator is willing to offer. A challenge to an entity on the list 304 would then include the custom bet entered by the spectator in the field 312 along with the odds proposed by the spectator. When a trigger point for the proposition is encountered for the spectator's proffered wager, the wager may then be solicited.

FIG. 4 illustrates that bets may be customized to the spectator-bettor so that different bettors get different proposition offers based on their past wagering history, which is accessed at block 400. This may be accomplished by using the spectator's computer simulation account and IP address to know the bettor-spectator's geo location. Moving to block 402, the bettor-spectator is offered one or more proposition bets based on the bettor's past history of wagering, so that the proffered wagers are tailored to the individual bettor to appeal to the bettor based on similar past wagers the bettor has made.

FIG. 5 illustrates a follow-on UI 500 that may be presented to the spectator who has placed a bet using the UI 300 in FIG. 3. As shown, the UI 500 includes an advisory message 502 as whether the spectator is winning or losing a bet on current simulation trajectory. A selector 504 may be provided to allow the spectator to close out the bet, generally at odds less than those accepted at the time of the bet. If desired, a selector 506 may be provided to allow the spectator to double the bet if, for example, it looks like the bet will be a winning one.

FIG. 6 illustrates a UI 600 that may be presented to a spectator to allow the spectator to accept (using a first selector 602) “bookie odds”, i.e., odds established by the provider, or to accept parimutuel odds (using a second selector 604). Parimutuel odds are odds that are established based on the actual wagers placed by the betting public, and typically change as betting progresses.

It will be appreciated that whilst present principals have been described with reference to some example embodiments, these are not intended to be limiting, and that various alternative arrangements may be used to implement the subject matter claimed herein.

1. A system comprising:
at least one computer simulation controller;
at least one computer simulation source configured to receive input from the computer simulation controller to control presentation of a computer simulation presented on at least one display, the computer simulation source comprising at least one processor and at least one storage accessible to the processor and comprising instructions executable by the processor to:
access computer game data comprising past histories of players playing a computer simulation comprising an e-sports or computer game, the past histories comprising prior play of the computer simulation, the computer game data comprising win-loss ratios, kill statistics, and highest simulation level achieved;
based at least in part on the computer game data, determine wagering odds for at least one simulation proposition;
overlay on the computer simulation at least one user interface (UI) configured to enable input, using the simulation controller, of a bet using the wagering odds; and
based on an outcome of the simulation proposition, present indication of a winner of the bet.

2. The system of claim 1, wherein the computer simulation source comprises a network server communicating with the computer simulation controller over a computer network.

3. The system of claim 1, wherein the computer simulation source comprises a computer game console communicating directly with the computer simulation controller.

4. The system of claim 1, wherein the instructions are executable to remove the UI from the computer simulation responsive to input from the simulation controller.

5. The system of claim 1, wherein the instructions are executable to present recommended wagers output by a recommendation engine.

6. The system of claim 1, wherein the instructions are executable to present a list of available bets.

7. The system of claim 1, wherein the instructions are executable to accept input of a custom bet.

8. The system of claim 1, wherein the wagering odds are established parimutuelly.

9. The system of claim 1, wherein the wagering odds are established using past simulation play statistics.

10. A method comprising:
establishing odds for at least one future event in a computer simulation; and
overlaying onto at least one presentation of the computer simulation at least one user interface (UI) showing the odds and indicating the event to permit a viewer to select to bet on the future event occurring or not.

11. The method of claim 10, comprising establishing the odds based at least in part on statistics of at least one player of the computer simulation, the statistics being related to past performance of the player in playing the computer simulation.

12. The method of claim 10, comprising establishing the odds based at least in part parimutuelly using bets from viewers of the computer simulation.

13. The method of claim 10, wherein the UI comprises a list of counterpart bettors.

14. The method of claim 10, wherein the UI comprises a list of bets with respective odds.

15. The method of claim 10, wherein the UI comprises at least one field for a user to enter a custom wager.

16. The method of claim 10, comprising:
accessing a first network address indicating a first geo-location;
accessing a first account associated with the first geo-location;
presenting to a first user device a first proposition bet related to a first computer game based at least in part on the first account and first geo-location;
accessing a second network address indicating a second geo-location;
accessing a second account associated with the second geo-location; and
presenting to a second user device a second proposition bet related to the first computer game based at least in part on the second account and second geo-location.

17. An apparatus comprising:
at least one computer storage that is not a transitory signal and that comprises instructions executable by at least one processor to:
send a first network address indicating a first geo-location to a network;
send information pertaining to a first account associated with the first geo-location to the network;
overlay on a computer simulation being presented on a display at least one wagering proposition related to the computer simulation and based at least in part on the information pertaining to the first account; and
send acceptance of the wagering proposition to a wagering source.

18. The apparatus of claim 17, wherein the wagering source comprises a network source.

19. The apparatus of claim 17, wherein the instructions are executable to:
overlay odds associated with the wagering proposition on the computer simulation.

20. The apparatus of claim 17, wherein the instructions are executable to:
overlay identifications of one or more potential partner bettors with whom to wager.
